(19) United States
(12) Patent Application Publication
(10) Pub. No.: US 2012/0287824 A1
(43) Pub. Date: Nov. 15, 2012

(54) ENABLING EXECUTION OF INTELLIGENT NETWORK SERVICES

(75) Inventors: Maurice Hiep, Wassenaar (NL); Hans Van Oortmarssen, The Hague (NL); Elena Mancevska, Voorburg (NL)

(73) Assignee: Koninklijke KPN N.V., The Hague (NL)

(21) Appl. No.: 13/519,586

(22) PCT Filed: Dec. 23, 2010
(86) PCT No.: PCT/EP10/70675

§ 371 Date: Jun. 28, 2012

(30) Foreign Application Priority Data
Dec. 29, 2009 (EP) 09180870.9
Jan. 29, 2010 (EP) 10152126.8

(51) Int. Cl. H04W 4/16

(52) U.S. Cl. 370/259

(57) ABSTRACT

A method for enabling the execution of an Intelligent Network (IN) service provided by a first IN service control system (6) in a telecommunications network (30) by means of an IN service trigger for invoking the triggering of the IN service, the telecommunications network comprising a switching system (3) communicatively coupled to a subscriber database (7), the first IN service control system, and a second IN service control system (33), wherein a trigger for the IN service cannot be provided by the subscriber database, and wherein the method is performed by the second IN service control system. The method comprises receiving from the switching system one or more parameters originating from the subscriber database. After receiving, information is identified from the received parameters indicating that the IN service provided by the first IN service control system is to be executed. An IN service trigger based on the identified information is formed, and the IN service trigger is sent to the switching system.

### FIELD OF THE INVENTION

The invention relates to a method for enabling execution of an Intelligent Network (IN) service. The invention further relates to a computer readable medium for performing, when executed by a processor, such method. The invention further relates to an IN service control system being part of a telecommunications network. Finally, the invention relates to a telecommunications network comprising such IN service control point.

### BACKGROUND OF THE INVENTION

An Intelligent Network (IN) is a network architecture intended both for fixed as well as mobile telecommunications networks. It allows operators to differentiate themselves by providing value-added services in addition to the standard telecommunications services.

In such an Intelligent Network, the control and switching functions within a network are separated such that the control of a Service Switching Point (SSP) is handled by one or more Service Control Points (SCP). Communication between the SCP and the SSP is performed by using an IN control protocol. Various IN standards define an IN protocol. A widely used IN standard is CAMEL (Customised Applications for Mobile networks Enhanced Logic), which provides a family of IN protocols known as CAP (CAMEL Application Part) Phase 1-4. The INAP (Intelligent Network Application Protocol) also defines standardized IN protocols, including CS-1 (Capability Set 1) and CS-2 (Capability Set 2). Certain network equipment vendors support non-standardized extensions of these protocols, such as CS-1+, and different vendors may have their own CS-1+ version. Communication between an SSP, in GSM systems for example embodied by a Mobile Switching Center (MSC), and different SCPs may be performed via different IN protocols provided the IN protocol is supported by both the SCP and SSP.

Intelligent Networks enable the development of specific services by an operator without the need to implement them in the switching network. The only condition is that the newly developed service can communicate with the switching network. In practice, many services are developed by network equipment vendors that are also responsible for switching network elements in the network, e.g. an MSC. These equipment vendors create their own IN architecture. As a result, besides standardized IN protocols, some vendors use a vendor-specific IN protocol for communication between the SSP and the SCP providing the vendor-specific service. An example of a vendor-specific IN protocol is CS-1+ used by Ericsson, and other vendors have implemented their own variation of IN protocols. An SSP from one vendor using a certain variation of a standard protocol generally cannot communicate with an SCP of another vendor using that vendor's variation of the standard protocol.

Hereinafter, the expression CS-1+ will be used to refer to a non-standardized IN protocol.

As a result, a company acquiring a vendor-specific IN platform cannot easily switch to a different IN platform without losing the ability to perform the vendor-specific services available on the vendor-specific IN-platform. This situation is referred to as “vendor lock-in”, where it is not possible to replace network equipment from one vendor with equipment from another vendor because this will lead to loss of functionality of one or more services. Additionally, if there is a desire to add services related to a vendor-specific service of a different vendor, it may even be necessary to acquire a number of switching network components of the different vendor. This acquisition and the need to provision multiple databases, each database related to a different vendor-specific switching network, raises costs significantly. Therefore, there is a desire to avoid such “vendor lock-in”.

The prior art document EP1005239 discloses a mediator for executing services in a telecom network consisting of multiple sub networks owned by different operators. SSP1 and SSP4 are owned by different operators. In this prior art solution, an IN service selection and distribution function based on the dialed Service Number is taking place. In this prior art solution, the problem of connection between standardized and non-standardized protocols is not solved, and is not to be solved. In EP1005239 SSP1 and SSP2 are making use of the same standardized protocols.

The prior art document WO 2008/071553 discloses a method to establish connections between a Packet Switched network and a Circuit Switched network by adding a prefix based on an A number (Calling Party number). Thereafter a specific service selection is executed based on the A number. In this prior art document the problem is solved of providing the same services to a customer independent of his use of the access network. In WO 2008/071553 only an IN service is used.

### SUMMARY OF THE INVENTION

It is an object of the present invention to provide a method of enabling execution of an IN service in a telecommunications network that effectively separates non-standardized components from the standardized network. For this purpose, the present invention provides a method for enabling the execution of an Intelligent Network (IN) service by providing a translation of the triggering parameters for be the respective protocols understood by the non-standardized components and the standardized components in the network. For this purpose, the present invention provides a method for enabling the execution of an Intelligent Network (IN) service to be provided by a first IN service control system in a telecommunications network by means of an appropriate translation to an IN service trigger for invoking the triggering of the IN service. The telecommunications network optionally can comprise a switching system communicatively coupled to a subscriber database and to the first IN service control system and to a second IN service control system. In case a designator for the IN service cannot be provided by the subscriber database to the first IN service control system directly, for example for reason of lack of protocol compatebility between the non-standardized components and the standardized components in the network, the method can be performed by invoking the assistance of a second IN service control system. The method can comprise the steps of: in the second IN service control system receiving, optionally from the switching system, one or more parameters originating from the subscriber database; identifying information from the received parameters indicating that the IN service provided by the first IN service control system is to be executed; forming an IN service trigger for the first IN service control system based on the identified information, by a translation of the identified information such as the triggering parameters for IN services; and sending the IN service trigger to the first IN service control system, optionally via the switching system.

Thus in the present patent application, the information identification is not used for an IN service selection, but for a translation of triggering parameters stored in the subscriber database into the IN service trigger or triggering parameters needed for triggering of the IN service provided by the first IN service control system. The IN service trigger or triggering parameters are propagated, optionally via the switching system, from the second IN service control system. Different protocols are used for triggering of the first and the second IN service control system. In this invention the IN protocol used on the first IN system is different from the protocol used on the second IN system where the protocol of the first IN system can be a non-standard protocol.

Such method allows for the use of non-standardized IN services in a standardized IN service telecommunications network. As a result, network components do not need to be selected based on the IN services provided by a certain vendor, but may relate to other characteristics of the network component. For example, a subscriber database can be selected on its merits without regard to capability with vendor-specific IN services running on the network. The selection is not limited to subscriber databases offered by vendors of specific, desirable IN services. Constructing and maintaining a network will be possible with reduced cost, while the services offered to the end user remain the same.

In some embodiments, the method further comprises obtaining a trigger from the switching system for initiating the receiving of the one or more parameters. Such triggering allows the use of the second IN service control system in a similar way as the first IN service control system.

The one or more parameters obtained from the subscriber database may comprise a parameter defined by a telecommunications standard, and the IN service trigger is not defined in the telecommunications standard.

In some embodiments, forming an IN service trigger includes using a conversion table, the conversion table comprising a first list and a second list, the first list comprising information indicative of an IN service to be executed from the subscriber database, and the second list comprising one or more corresponding IN service triggers.

Forming the IN service trigger may include adding a prefix to a called party number. The prefix may be representative for the IN service to be provided by the first IN service control system. The switching system is capable of reading the number with prefix and may be configured to react to the prefix to invoke the IN service. This may be accomplished, for example, by using a number based triggering feature already included in the switching system. In this way, the switching system may be configured using existing features of the switching system to read the prefix and react to the prefix by triggering the corresponding IN service.

In some embodiments of the invention, the protocol used between the switching system and the first IN service control system is a CS-1+ protocol. Such protocol is generally a vendor-specific protocol with additional functionality over a standard protocol like the CS-1 protocol.

In some embodiments, the one or more parameters originating from the subscriber database include at least one of originating CAMEL subscription information and terminating CAMEL subscription information. CAMEL is a widely used IN service standard.

In some embodiments, the telecommunications network further comprises a further switching system communicatively coupled to the switching system and the second IN service control system, prior to the receiving of the one or more parameters from the switching system, the method further comprising: receiving one or more parameters originating from the subscriber database from the further switching system; identifying information from the received parameters indicating that the call should be handled further by the switching system; forming a switching system designator based on the identified information for allowing call rerouting towards the switching system; and sending the switching system designator to the further switching system. In such extended telecommunications network, the method allows the rerouting of calls towards the switching system if the further switching system cannot derive this destination from the information obtained from the subscriber database.

Forming the switching system designator may include adding a prefix to at least one of a called party number.

Some embodiments of the invention relate to a computer readable medium for performing, when executed by a processor, an embodiment of the method mentioned above.

Some embodiments of the invention relate to an IN service control system being part of a telecommunications network, the system being communicatively coupled to a switching system which is communicatively coupled to a subscriber database, and an IN service control system for providing an IN service to be executed, wherein the system is arranged to perform the method defined above. The system may further be communicatively coupled to a further switching system also communicatively coupled to the switching system.

In addition, some embodiments of the invention relate to a telecommunications network comprising: a subscriber database; a first IN service control system; a second IN service control system; and a switching system communicatively coupled to the subscriber database, the IN service control system and the second IN service control system; wherein the second IN service control system is arranged to perform the method as mentioned above. The telecommunications network may further comprise a further switching system communicatively coupled to the switching system and the second IN service control system.

Further aspects of the invention and embodiments as defined in the claims will be clarified with reference to the attached drawings and corresponding description. It will be understood that the invention is not in any way restricted to the embodiments disclosed in the drawings.

### DETAILED DESCRIPTION OF THE DRAWINGS

The following is a description of certain embodiments of the invention, given by way of example only and with reference to the drawings.

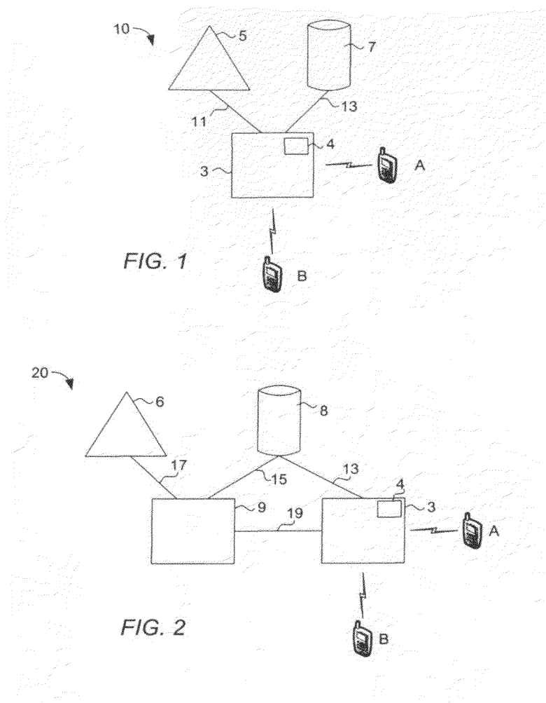

FIG. 1 schematically depicts a fully standardized IN telecommunications network;

FIG. 2 schematically depicts an IN telecommunications network comprising vendor-specific switching network components;

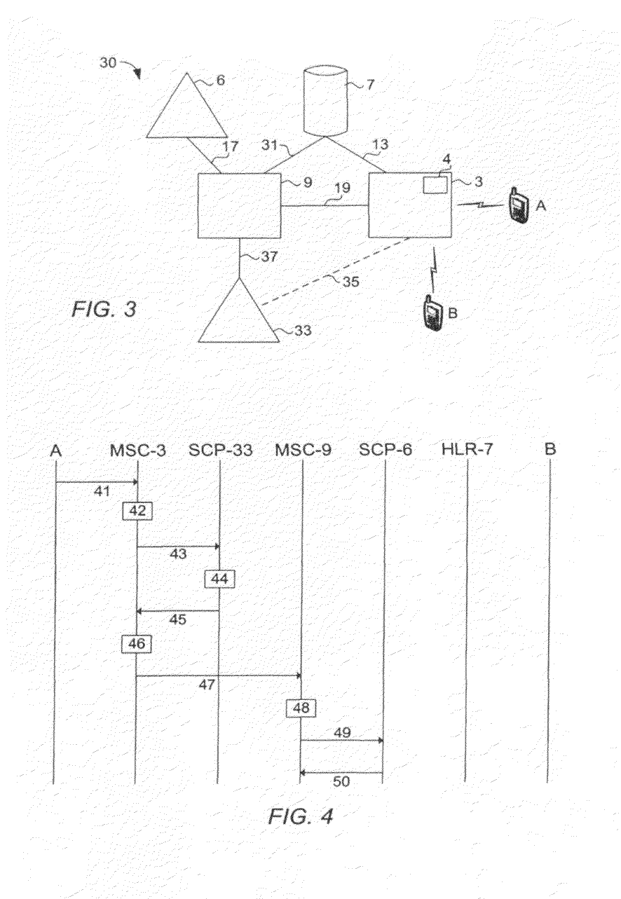

FIG. 3 schematically depicts an IN telecommunications network that may be used in some embodiments of the invention;

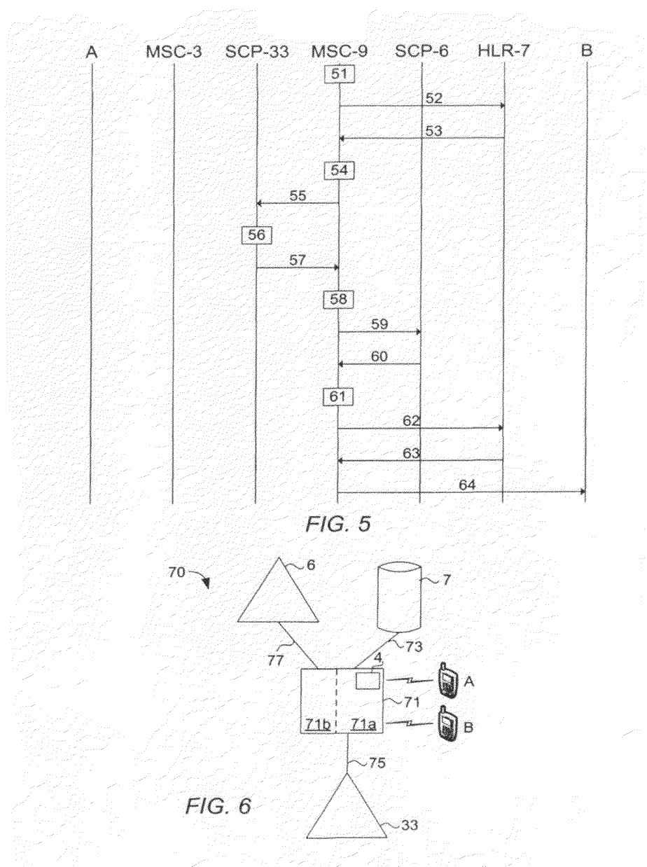

FIGS. 4 and 5 schematically depict a call flow diagram between two subscribers to non-standardized IN services in the network of FIG. 3; and

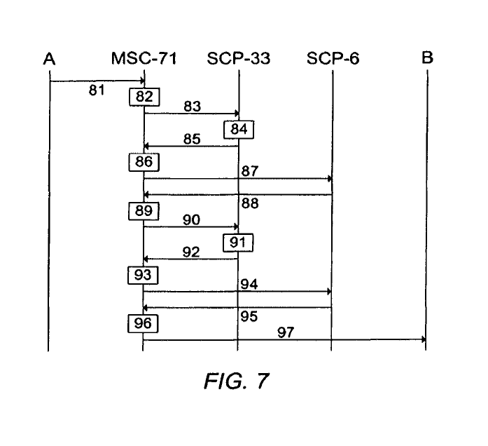

FIG. 6 schematically depicts another IN telecommunications network that may be used in some embodiments of the invention.

FIG. 1 schematically depicts a fully standardized IN telecommunications network 10. In this description, standardized refers to being compatible with a widely adopted IN standard, for example the IN standard used in 3GPP (3rd Generation Partnership Project) telecommunications systems referred to as CAMEL. Besides the terminology standardized, reference will be made to the expression non-standardized. The expression non-standardized should be interpreted to mean not compatible with an IN standard. Throughout the description, the term “non-standardized” will be used interchangeably with the expression “vendor-specific”. The latter expression relates to proprietary elements of network components. These elements may be developed by a specific vendor such as Ericsson, for example by addition of specific coding to the standard CS-1 protocol to obtain the CS-1+ Ericsson specific protocol version. In the examples described where the standard is considered to be CAMEL or INAP, using a protocol not supported by CAMEL or INAP will be identified as a non-standardized protocol.

The IN network 10 comprises a switching system 3 communicatively coupled to a IN service control system 5 and a subscriber database 7. Additionally, the switching system 3 can communicate with one or more subscribers, e.g. users of mobile stations A and B further referred to as parties A and B respectively. The switching system 3 may comprise a local database 4 to enable provisioning of subscriber related data from the subscriber database 7, in particular for those subscribers that are present in the service area of the switching system, e.g. parties A and B in FIG. 1.

In this description, embodiments of the system will be described with reference to a GSM telecommunications system. For this reason, a switching system will be referred to as a Mobile Switching Center (MSC), a subscriber database will be referred to as a Home Location Register (HLR), a local database in the MSC will be referred to as a Visitor Location Register (VLR), and an IN service control system will be referred to as a Service Control Point (SCP). Similarly, interfaces between an SCP and an MSC relate to communication between a Service Switching Function (SSF) residing in the MSC and a Service Control Function (SCF) residing in the SCP in accordance with a certain protocol. It must be understood that embodiments of the invention may also be applied in different types of telecommunications systems. For example, in an UMTS system, the combination of a Mobile Switching Center Server (MSC-S) and a Circuit Switched Media Gateway (CS-MGW) can serve as a switching system.

In this exemplary embodiment, the SCP 5 is arranged to provide one or more IN services. Examples of IN services include, but are not limited to providing prepaid services for a calling party, prepaid services for a called party, toll free calling, account card calling, short number translation, creating a mobile virtual private network (MVPN), establishing multiparty calls, modifying a called party number, providing private branch exchange services, “HomeZone” and “Office Zone” services, and many more. The MSC 3 and the SCP 5 communicate via an interface 11 using a communication protocol complying with an IN standard, for example the CAP protocols as supported by the CAMEL standard.

The HLR 7 is a subscriber database comprising data records of all users that subscribe to services provided by the telecommunications network. The data records may comprise one or more parameters related to the telephone number of a subscriber, information related to the kind and number of IN services the user subscribes to and further data related to the subscriber. In CAMEL, the information in a data record is referred to as CAMEL Subscription Information (CSI). The CSI related to a calling party may be referred to as Originating CSI (O-CSI). The CSI related to a called party may be referred to as Terminating CSI (T-CSI). With respect to a subscriber, a data record may contain both O-CSI and T-CSI. Information in the O-CSI and T-CSI may be used to invoke a triggering of communication between the MSC 3 and the SCP 5 to enable the launch of an IN service.

The MSC 3 and the HLR 7 communicate via standardized interface 13 complying with a 3GPP standard. An example of such an interface is a standard MAP interface (Mobile Application Part). The VLR 4 in the MSC 3 can retrieve and store data from the HLR 7 via the interface 13. The data record in the VLR 4 regarding a certain subscriber may only comprise selected elements of the corresponding data record in the HLR 7 as will be known to a person skilled in the art.

Vendors may provide specific IN services that are not readily available otherwise. It is desirable to be able to provide such services in the network of FIG. 1. However, in some cases, the SCP providing such services can only be provided if the SCP is coupled to a switching system from the same vendor. Furthermore, a subscriber database may need to be provisioned in a certain way to enable execution of the vendor-specific IN service. As a result, it is then needed to use an HLR from the same vendor as well. The addition of one or more vendor-specific IN services may thus limit the choice of other components in the telecommunications network. Thus a number of components may need to be acquired from the same vendor, and vendor choice will be limited for replacement or expansion of network equipment.

It is desirable to increase the functionality of an IN telecommunications network by introducing vendor-specific services without the need to replace many network components. There is a need to enable separation of vendor-specific portions of a telecommunications network and standardized portions within the telecommunications network such that the number of vendor-specific components can be minimized without limiting overall network functionality.

It has proven to be possible to use a standardized MSC in combination with a vendor-specific MSC, where the standardized MSC is used for connections with subscribers. Such embodiment is schematically depicted in FIG. 2. FIG. 2 schematically depicts an IN telecommunications network 20 comprising a standardized switching system 3 in combination with a number of vendor-specific components, in particular an SCP 6, an HLR 8, and an MSC 9. The vendor-specific components all relate to the same vendor and may form a vendor-specific IN services architecture. The vendor-specific IN services architecture may deploy for example a vendor-specific CS-1+ protocol version.

The SCP 6 is arranged to provide one or more vendor-specific IN services. The SCP 6 is communicatively coupled with the MSC 9, which in its turn is communicatively coupled to the standardized MSC 3. The vendor-specific HLR 8 is communicatively coupled to both the vendor-specific MSC 9 and the standardized MSC 3.

The interface 13 between the HLR 8 and the MSC 3 is a standardized interface similar to the interface between the HLR 7 and the MSC 3 in FIG. 1, for example a standard MAP interface. The interface 15 between the HLR 8 and the MSC 9 is a non-standardized interface. The interface 15 may be a vendor-specific MAP interface. That is, fields in the MAP protocol reserved for private extensions are utilized by the vendor. As a result, components of other vendors or standardized components coupled to this interface may not be able to fully interpret the information that is transferred via the interface.

Also the interface 17 between the SCP 6 and the MSC 9 is a vendor-specific interface. For example, if the MSC 9 is a vendor-specific MSC, the interface 17 may be an interface using a vendor-specific protocol, such as a CS-1+ protocol.

Finally, the MSC 9 and the MSC 3 are connected via a standard interface 19, e.g. an ISUP interface (ISDN User Part).

The HLR 8 is a subscriber database including data records with subscriber profiles. Besides the standard information already discussed with reference to HLR 7 in FIG. 1, the subscriber profile further comprises IN information that may be used for triggering one or more vendor-specific services. Note that this trigger information can only be communicated via a vendor-specific interface, e.g. via private extension in fields in a MAP interface. Consequently, the VLR 4 in the MSC 3 will not retrieve this trigger information, as the MSC 3 and the HLR 8 are communicatively coupled via a standardized interface 13.

The telecommunications network 20 has limited capability for executing requests related to vendor-specific IN services provided by SCP 6. In particular, the network 20 may only be able to execute IN services if the standardized MSC 3 has the capability to reroute the call towards the MSC 9 upon analysis of standard O-CSI in the VLR 4 or upon analysis of standard T-CSI retrieved from the HLR 8. The standard O-CSI and/or T-CSI does not include the additional information required for invoking the IN service in SCP 6. This analysis would include recognition that the calling and/or called party is a subscriber to an IN service provided by the vendor of the SCP 6 and MSC 9. The call is then rerouted to the MSC 9 without any further knowledge regarding the specific IN service. Thus, rerouting to MSC 9 may only be effective where only a single IN service was offered for a calling party and/or called party in SCP 6.

If the HLR in the network 20 of FIG. 2 is a standardized HLR like HLR 7 in FIG. 1, the automatic rerouting of calls by MSC 3 to MSC 9 does not necessarily enable execution of an IN service for a called party or a calling party. In particular, if the SCP 6 provides more than one IN service, the MSC 9 will not know which IN service should be triggered, as the MSC 9 has no knowledge of the triggering information and is unable to obtain such information from the standardized HLR. As a result, the requested IN service cannot be performed.

FIG. 3 schematically depicts an IN telecommunications network 30 that may be used in some embodiments of the invention. The network comprises a standardized MSC 3, a vendor-specific MSC 9, and a vendor-specific IN SCP 6. The connections between these three components are similar to the connections described with reference to FIG. 2.

In contrast to the network 20 of FIG. 2, the network 30 comprises a standardized HLR 7 as presented in FIG. 1. The HLR 7 is communicatively coupled to the MSC 3 via standardized interface 13. Furthermore, the HLR 7 is communicatively coupled to the MSC 9 via a standardized interface 31.

The network 30 further comprises a second SCP 33. The SCP 33 is a standardized SCP communicatively coupled to the vendor-specific MSC 9 via a standardized interface 37. The interface 37 may be an interface compatible with CAMEL or INAP, e.g. an interface using the CAP protocol or the CS-1 protocol.

The SCP 33 is arranged to identify information within the O-CSI and/or T-CSI stored in the HLR 7 indicative of an IN service to be executed, referred to hereafter as CAMEL trigger information. The SCP 33 is further arranged to form an IN service trigger based on this CAMEL trigger information. The IN service trigger is arranged to invoke the triggering of an IN service provided by the SCP 6. The CAMEL trigger information may be provided to the SCP 33 by the MSC 9 via the interface 37. The IN service trigger may be transferred via the same interface 37 towards the MSC 9.

By forming an IN service trigger in a separate SCP and providing the MSC 9 with such designator, a vendor-specific IN service provided by a vendor-specific SCP may be executed via a vendor-specific MSC even though all other components in the telecommunications network as well as the interfaces in between are standardized, and do not include vendor-specific protocols or extensions usually required to invoke the vendor-specific IN service. In FIG. 3, the separation between the vendor-specific components and the standardized components are schematically separated by line 39, the vendor-specific components being located in area I and the standardized components being located in area II respectively. The effective separation and interworking between non-standardized and standardized components within the telecommunications network enables flexible construction and maintenance of a telecommunications network without vendor lock-in without compromising the network's functionality.

Thus a method is disclosed which can comprise the steps of: receiving in a second IN service control system (33) from a switching system (9) one or more parameters originating from the subscriber database (4, 7); identifying information from the received parameters indicating that an IN service provided by a first IN service control system (6) is to be executed; forming an IN service trigger for the first IN service control system based on the identified information, by a translation of the identified information; and sending the IN service trigger to the first IN service control system (6), optionally via the switching system (9). The aforementioned information can comprise (but not exclusively) Service Key, Event Type BCSM indicating a Detection Point event and Redirection Information. The parameters and their values contained in this information can be used in any combination to identify the service to be triggered on the first IN service control system, by which a service trigger can be formed.

Optionally, the standardized SCP 33 is further communicatively coupled to the standardized MSC 3 via a standardized interface 35, for example an interface compatible with CAMEL using the CAP protocol. Such interface 35 is in particular advantageous if the standardized MSC 3 is not capable of recognizing that the service to be provided to an calling party is a service provided by the SCP 6. In some embodiments, the SCP 33 merely arranges for call rerouting, e.g. by sending a switching system designator via the interface 35. Providing an IN service trigger is still performed via interface 37. In some other embodiments, the SCP 33 may, via interface 35, not only arrange for execution of triggering of the correct vendor-specific IN service, but also arrange for rerouting of the call to the MSC 9. In such embodiments, a switching system designator may be sent that can also be used as an IN service trigger. In other embodiment, both a switching system designator and an IN service trigger may be sent by SCP 33 to the MSC 3 via interface 35.

In some embodiments, the SCP 33 is arranged to form the IN service trigger and/or the switching system designator by means of using a conversion table. Such conversion table may comprise a number of lists, for example two. In case of the formation of an IN service trigger a first list may comprise information indicative of an IN service to be executed. Such information may be identified from the parameters obtained from the subscriber database and received via at least one of MSC 9 and MSC 3. A second list may then comprise one or more IN service triggers, each IN service trigger corresponding to one or more entries in the first list. In case of the formation of a switching system designator a similar approach may be taken. The use of a conversion table is easy to implement, and the conversion table may be made configurable for ease of maintenance, so that for example the operator is able to configure operator-specific values for the information indicative of an IN service execution (the first list) and IN service trigger (the second list).

The IN service trigger and/or switching system designator may enable triggering based on recognition of certain numbers, number ranges, prefixes, suffixes or combinations thereof.

The forming of any one of the IN triggering designator and switching system designator may include adding a prefix to a called party number. The prefix may be added in case of mobile originating or mobile terminating call scenario, as will be explained with reference to FIGS. 4 and 5. Adding this prefix allows for quick recognition by the MSC 9 what IN service needs to be executed. The prefix may thus be representative for the IN service to be provided by the SCP 6. The use of this type of so-called number based triggering is easy to implement.

Alternatively, in case the MSC 3 requests further instructions for routing a call, the prefix may be representative for designation MSC, i.e. MSC 9. In this case, the prefix allows for quick recognition by the MSC 3 to what switching system the call should be routed, in this case to the MSC 9. Preferably, the prefix for routing can also be used to trigger the desired IN service when the call arrives at MSC 9. This would prevent the need for further actions by the MSC 9 like removing the prefix, questioning the HLR 7, and sending parameters obtained from the HLR 7 towards the SCP 33 to obtain a prefix that can be used as IN service trigger.

The invention will now be further described with reference to an example performed in the network 30 of FIG. 3. A flow diagram of the example is schematically shown in FIGS. 4 and 5. The example is not considered to be limiting and merely serves the purpose of illustrating certain aspects of the invention.

The example relates to a call made from calling party A to called party B. Party A and party B are both subscribers registered in the HLR 7. Moreover, to limit the number of steps to be discussed, the assumption is made that trigger data of both parties A and B are already stored in the VLR 4 of the MSC 3 in a way known to a person skilled in the art. Calling party A is a subscriber to an IN service provided by the SCP 6, for example MVPN. Called party B is a subscriber to a different IN service provided by the SCP 6, for example a prepaid service. The standardized components in the network 30 are compatible with CAMEL. Interface 17 between SCP 6 and MSC 9 uses the CS-1+ protocol to communicate. Finally, the assumption is made that the MSC 3 is not capable of recognizing that the IN services mentioned in the HLR 7 with respect to parties A and B are provided by SCP 6 which can be addressed via MSC 9. Consequently, the MSC 3 and the SCP 33 are communicatively coupled via interface 35.
The example depicted in FIGS. 4 and 5 starts with action 41, which corresponds to party A dialing the telephone number of party B. As a result, the call is received by the MSC 3. In action 42, the MSC recognizes that the call originates from party A, and reads CAMEL subscription information related to the calling party, also referred to as O-CSI, out of the VLR 4.
The O-CSI comprises information regarding the one or more IN service(s) the calling party is subscribed to. In particular, the O-CSI comprises information about the SCP that should be consulted for further processing to enable such IN service, in the form of an SCP address. Additionally, the O-CSI comprises a Service Key. The SCP address allows the MSC to handover the call control to the SCP and to the IN service (within the SCP) identified in the Service Key. The O-CSI also comprises information regarding one or more detection points. The detection points relate to points in a finite state model (or Basic Call State Model, BCSM) when certain information, in this case provided in the O-CSI, needs to be used while processing the call.

In this example, MSC 3 identifies SCP 33 and the relevant IN service using the SCP address and the Service Key in the O-CSI. In action 43, the MSC 3 sends a trigger via interface 35 towards the SCP address obtained from the O-CSI and associated with SCP 33. In action 44, SCP 33 then analyses the CAMEL trigger information and forms an IN service trigger designator. The CAMEL trigger information may include the SCP address, Service Key, and detection points, and the IN service trigger designator may take the form of a prefix appended to the number of the called party, hereinafter referred to as the B number. The SCP 33 may make use of a conversion table, as described above, in which the combination of CAMEL triggering information indicates the applicable IN service trigger designator.

In action 45, SCP 33 provides the IN service trigger designator to the MSC 3. In action 46 the MSC 3 then analyses the IN service trigger designator, and recognizes that the call should be routed to MSC 9. The routing is represented by action 47. In MSC 9 the prefix is analyzed in action 48 and based on the analysis a triggering scheme to trigger the desired IN service is determined. In action 49, a dialogue in accordance with the CS-1+ protocol is initiated between MSC 9 and SCP 6. As a result of this dialogue, if party A is allowed to make this call (e.g. the B number is not blacklisted for the A party) the desired MVPN service is started in action 50. The actions related to activation of the IN service for the calling party A have now been performed.

Thus, in the example, the applicable IN service is indicated using the IN service trigger designator rather than using vendor-specific triggering information, such as data included in vendor-specific CS-1+ protocol extensions. Where the IN service trigger designator is a prefix appended to the B number, the MSC 9 is already capable of reading the number with prefix and may be configured to react to the prefix to invoke the desired IN service. This may be accomplished, for example, by using a number based triggering feature already included in the MSC. In this way, the MSC may be configured using existing features of the MSC to read the prefix and react to the prefix by triggering the corresponding IN service.

Note that in this exemplary embodiment, SCP 33 directly provides the IN service trigger to MSC 3 in action 45. Alternatively, SCP 33 may upon analysis of the CAMEL trigger information form a switching system designator and provide this switching system designator to MSC 3, and MSC 3 then reroutes the call to MSC 9. However, this method of processing is subject to the limitations described above for invoking a vendor specific IN service in SCP 6.

FIG. 5 provides an overview regarding further actions performed with respect to the call including the activation of the IN service related to the called party B. After receiving a reply from the SCP 6 regarding the IN service related to calling party A in action 50, MSC 9 analyses the B number in action 51. This analysis will reveal that the B number relates to a mobile number. Consequently, MSC 9 interrogates HLR 7 in action 52 in order to obtain the routing information of called party B. The response of HLR 7 including the requested routing information is denoted as action 53. As HLR 7 is a standardized HLR, the user profile does not contain vendor-specific or otherwise private extensions that would allow MSC 9 to trigger one of the vendor specific IN services provided by SCP 6. The routing information sent by HLR 7 in action 53 comprises Terminating CAMEL Subscription Information (T-CSI). Just like the O-CSI, the T-CSI comprises information regarding the one or more IN service(s) the respective party is subscribed to, e.g. in the form of a Service Key, an SCP address for further handling of the call, and information regarding one or more detection points. In action 54, MSC 9 analyzes the T-CSI for called party B. Based on this analysis, MSC 9 triggers SCP 33 via the interface 37 in action 55.

In action 56, SCP 33 analyses the CAMEL trigger information for party B and forms a second IN service trigger designator, this time for the IN service of party B. As before, the IN service trigger designator may take the form of a prefix appended to the B number. In action 57, SCP 33 provides the second IN service trigger designator to MSC 9. In action 58, MSC 9 analyses the prefix and based on the analysis a triggering scheme to trigger the desired IN service is determined. Then, schematically denoted as action 59 and 60, a dialogue in accordance with the CS-1+ protocol is initiated between MSC 9 and SCP 6, and as a result of this dialogue, the desired prepaid service for party B may be started. The actions related to activation of the IN service for the called party B have now been performed.

Further processing is performed to process call with the IN services activated. For example, in action 61, the B number is analyzed in MSC 9 and is recognized as a mobile number. The HLR 7 is interrogated in action 62 to determine subscriber location information needed for handling the call (a suppression indicator is included to suppress T-CSI to enable further handling of the call as if no IN services were involved). In action 63 the required information is returned from HLR 7 and in action 64 the call is routed to party B.

The use of SCP 33 enables the network arrangement shown in FIG. 3 to trigger IN services provided by the vendor-specific SCP 6. The HLR 7 does not comprise information related to trigger designators for the MVPN IN service for calling party A and the prepaid IN service for called party B. Consequently, the O-CSI provisioned in the VLR 4 of MSC 3 may only help to reroute the call to MSC 9 if the MSC 3 is arranged to recognize the information needed to perform such rerouting. Even in such case, the MSC 9 will not be able to derive trigger designator information from the O-CSI regarding calling party A. Similarly the MSC 9 will not be able to derive trigger designator information from the T-CSI regarding called party B directly obtained from the HLR 7.

The SCP 33 uses information being part of the O-CSI and T-CSI of the parties involved to form IN services triggering designators that can be used by the MSC 9 to invoke the triggering of vendor-specific IN services.

FIG. 6 schematically depicts another IN telecommunications network 70 that may be used in some embodiments of the invention. In contrast to the network 30 of FIG. 3, the network 70 in FIG. 6 only comprises a single MSC 71. The single MSC 71 comprises a standardized portion 71a arranged to communicate via standard protocols and to execute tasks an MSC should be able to perform in accordance to an IN standard like CAMEL for use in 3GPP (3rd Generation Partnership Project) telecommunication networks. The MSC 71 further comprises a non-standardized portion 71b, e.g. specific for a certain vendor, arranged to communicate with non-standardized network components.

In the network 70 the standardized portion 71a of the MSC 71 is communicatively coupled to a standardized HLR 7 via a standard interface 73, e.g. an MAP interface. The standardized portion 71a is further communicatively coupled to the standardized SCP 33 via a standardized interface 75, e.g. an interface operating in accordance with a CAP protocol. The non-standardized portion 71b is communicatively coupled to the SCP 6 for providing vendor-specific IN services via a non-standardized interface 77. In case of a vendor-specific IN service, the non-standardized interface 77 may use the CS-1+ protocol for communication purposes.

The SCP 6, the HLR 7 and the SCP 33 operate in a similar manner as described with reference to FIGS. 3-5. The standardized portion 71a operates in a way resembling the operation of the MSC 3 in network 30. The operations performed by the non-standardized portion 71b were performed by the MSC 9 in network 30.

Considering the example presented with reference to FIGS. 4 and 5, the same call performed in the network 70 of FIG. 6 would lead to a similar call flow with the exception that actions 46 and 47 are not needed. The network 70 has the advantage that it comprises fewer network components, while the functionality can be of a similar level. Furthermore, less actions need to be performed.
Embodiments of the method as described in this application may be stored in a suitable way on a computer readable medium. As will be understood by a person skilled in the art, such a computer readable medium, when executed by a processor being located in the SCP 33, is able to perform embodiments of the method for enabling the execution of an IN service provided by SCP 6.
The invention has been described by reference to certain embodiments discussed above. It will be recognized that these embodiments are susceptible to various modifications and alternative forms well known to those of skill in the art but which all fulfill the requirements as recited in claim 1 of the present patent text. Accordingly, although specific embodiments have been described, these are examples only and are not limiting upon the scope of the invention.

### ABBREVIATIONS

3GPP 3rd Generation Partnership Project
BCSM Basic Call State Model
CAMEL Customised Applications for Mobile networks Enhanced Logic
CAP CAMEL Application Part
CS-1 Capability Set 1
CS-2 Capability Set 2
CSI CAMEL Subscription Information
CS-MGW Circuit Switched Media Gateway
GSM Global Systems for Mobile communication
HLR Home Location Register
IN Intelligent Network
INAP Intelligent Network Application Protocol
ISDN Integrated Services Digital Network
ISUP ISDN User Part
MAP Mobile Application Part
MSC Mobile Switching Center
MSC-S Mobile Switching Center Server
MVPN Mobile Virtual Private Network
O-CSI Originating CAMEL Subscription Information
SCF Service Control Function
SCP Service Control Point
SSF Service Switching Function
SSP Service Switching Point
T-CSI Terminating CAMEL Subscription Information
UMTS Universal Mobile Telecommunications System
VLR Visitor Location Register

1. A method for enabling the execution of an Intelligent Network (IN) service provided by a first IN service control system in a telecommunications network, the telecommunications network comprising a switching system being communicatively coupled to a subscriber database and to the first IN service control system and to second IN service control system, wherein a trigger for the IN service cannot be provided by the subscriber database to the first IN service control system directly, and wherein the method comprises:
receiving, in the second IN service control system one or more parameters originating from the subscriber database;
identifying information from the received parameters indicating that the IN service provided by the first IN service control system is to be executed;
forming an IN service trigger by translating the identified information to the IN service trigger for the first IN service control system; and
sending the IN service trigger to the first IN service control system.

2. The method according to claim 1, wherein the method further comprises obtaining a trigger from the switching system for initiating the receiving.

3. The method according to claim 1, wherein the one or more parameters obtained from the subscriber database comprise a parameter defined by a telecommunications standard, and the IN service trigger is not defined in said telecommunications standard.

4. The method according to claim 1, wherein forming the IN service trigger includes using a conversion table, the conversion table comprising a first list and a second list, the first list comprising information indicative of an IN service to be executed from the subscriber database, and the second list comprising one or more corresponding IN service triggers.

5. The method according to claim 1, wherein the IN service trigger can be used for triggering based on recognition of certain numbers, number ranges, prefixes, suffixes or combinations thereof.

6. The method according to claim 1, wherein forming the IN service trigger includes adding a prefix to at least one of a called party number.

7. The method of claim 6, wherein the prefix is representative for the IN service to be provided by the first IN service control system.

8. The method according to claim 1, wherein the protocol used between the switching system and the first IN service control system is a CS-1+ protocol.

9. The method according to claim 1, wherein the one or more parameters originating from the subscriber database include at least one of originating CAMEL subscription information and terminating CAMEL subscription information.

10. The method according to claim 1, wherein the telecommunications network further comprises a further switching system communicatively coupled to the switching system and the second IN service control system, prior to the receiving of the one or more parameters from the switching system, the method further comprising:
receiving one or more parameters originating from the subscriber database from the further switching system;
identifying information from the received parameters indicating that the call should be handled further by the switching system;
forming a switching system designator based on the identified information for allowing call rerouting towards the switching system; and
sending the switching system designator to the further switching system.

11. The method of claim 10, wherein the switching system designator can also be used as the IN service trigger.

12. The method according to claim 10, wherein forming the switching system designator includes adding a prefix to a called party number.

13. A computer readable medium for performing, when executed by a processor, a method for enabling the execution of an Intelligent Network (IN) service provided by a first IN service control system in a telecommunications network, the telecommunications network comprising a switching system being communicatively coupled to a subscriber database and to the first IN service control system and to second IN service control system, wherein a trigger for the IN service cannot be provided by the subscriber database to the first IN service control system directly, the method comprising:
receiving, in the second IN service control system or more parameters originating from the subscriber database;
identifying information from the received parameters indicating that the IN service provided by the first IN service control system is to be executed;
forming an IN service trigger by translating the identified information to the IN service trigger for the first IN service control system; and
sending the IN service trigger to the first IN service control system

14. An Intelligent Network (INI service control system being part of a telecommunications network, the system being communicatively coupled to a switching system which is communicatively coupled to a subscriber database, and a further IN service control system for providing an IN service to be executed, wherein the system is arranged to perform the method for enabling the execution of the IN service provided by the further IN service control system in the telecommunications network, wherein a trigger for the IN service cannot be provided by the subscriber database to the further IN service control system directly, the method comprising:
receiving one or more parameters originating from the subscriber database;
identifying information from the received parameters indicating that the IN service provided by the further IN service control system is to be executed;
forming an IN service trigger by translating the identified information to the IN service trigger for the further IN service control system; and
sending the IN service trigger to the further IN service control system.

15. The system of claim 14, wherein the system is further communicatively coupled to a further switching system also communicatively coupled to the switching system, and the system is further arranged for:
receiving one or more parameters originating from the subscriber database from the further switching system;
identifying information from the received parameters indicating that the call should be handled further by the switching system;
forming a switching system designator based on the identified information for allowing call rerouting towards the switching system; and
sending the switching system designator to the further switching system.

16. A telecommunications network comprising:
a subscriber database;
a first Intelligent Network (IN) service control system;
a second IN service control system; and
a switching system communicatively coupled to the subscriber database, the IN service control system and the second IN service control system;
wherein the second IN service control system is arranged to perform the method for enabling the execution of anIN service provided by the first IN service control system, wherein a trigger for the IN service cannot be provided by the subscriber database to the first IN service control system directly, the method comprising:
receiving one or more parameters originating from the subscriber database;
identifying information from the received parameters indicating that the IN service provided by the first IN service control system is to be executed;
forming an IN service trigger by translating the identified information to the IN service trigger for the first IN service control system; and
sending the IN service trigger to the first IN service control system.

17. The telecommunications network of claim 16, further comprising a further switching system communicatively coupled to the switching system and the second IN service control system, wherein the second IN service control system is further arranged for:
receiving one or more parameters originating from the subscriber database from the further switching system;
identifying information from the received parameters indicating that the call should be handled further by the switching system;
forming a switching system designator based on the identified information for allowing call rerouting towards the switching system; and
sending the switching system designator to the further switching system.

18. The method according to claim 1, wherein the one or more parameters originating from the subscriber database are received from the switching system and/or the IN service trigger is sent to the first IN service control system via the switching system.
